(19) United States
(12) Patent Application Publication
(10) Pub. No.: US 2008/0257163 A1
(43) Pub. Date: Oct. 23, 2008

(54) Gas-liquid separator, exhaust cleaner or air cleaner using the separator, and sterilizing air cleaner

(75) Inventors: Toshiki Kobayashi, Moriguchi-shi (JP); Taishi Kobayashi, Moriguchi-shi (JP)

Correspondence Address: JORDAN AND HAMBURG LLP, 122 EAST 42ND STREET, SUITE 4000, NEW YORK, NY, 10168, US

(73) Assignee: BIG BANG CO., LTD, Moriguchi-shi (JP)

(21) Appl. No.: 11/788,273

(22) Filed: Apr. 19, 2007

(51) Int. Cl. B01D 50/00

(52) U.S. Cl. 96/376; 55/403

(57) ABSTRACT

A gas-liquid separator of one aspect of the invention comprises; an inflow barrel; a main cylindrical barrel on downstream of the inflow barrel, which has an inner barrel duct and is constructed to induce rotational momentum on to-be cleaned gas having flown in from the inflow barrel; a plurality of subordinate cylindrical barrels that have diameters smaller than that of the main cylindrical barrel and are serially connected as adjoined to downstream end of the main cylindrical barrel; a connector cylindrical barrel that has diameter smaller than those of the subordinate cylindrical barrels and connects inside spaces of the subordinate cylindrical barrels; and liquid receivers on beneath of the subordinate cylindrical barrels; and an outflow barrel at downstream end of the series of the subordinate cylindrical barrels.

### CROSS-REFERENCE TO RELATED APPLICATION

This application is based upon the prior Japanese Patent Application No. 2004-292005, filed on Oct. 4, 2004 and publicized on Apr. 20, 2006 as JP-2006-102618A; the entire contents of which are incorporated herein by reference.

### FIELD OF THE INVENTION

This invention relates to: a gas-liquid separator for removing, from air, liquid that has adsorbed hazardous materials such as dark-smoke materials in exhaust gas and dusts or particulates in the air; an exhaust gas cleaner for diesel engine or the like or an air cleaner, utilizing such gas-liquid separator; and a sterilizing air cleaner.

### BACKGROUND ART

Exhaust gas emitted from automobile engines or other engines commonly includes hazardous materials such as carbon monoxide, hydrocarbons, and nitrogen oxides. Thus, various regulations are executed to cope with air pollution. Recently, dark smoke materials in diesel engine exhaust are especially in a focus of attention, as being referred as diesel exhaust particulates (DEP). The environmental standard regulation in Japan stipulates regulating of suspended particulate matters (SPM) in the air, having diameter of 10 micro meter or less, while the diesel exhaust particulates have diameters of 0.1 micrometers or less. Due to such extreme fineness of the exhaust particulates, direct removal of the diesel exhaust particulates themselves is physically hard to be implemented. Such fine smoke dusts as suspended particulates induce air pollution; thus, endeavored is investigation for decreasing the amount of such particulates in the diesel exhaust.

A category of conventional exhaust cleaner for diesel engine is a catalyst filter that is mounted as inserted in a portion of an exhaust pipe. Such a filter decreases the amount of the particulate matters (PM) by 70-80%; nevertheless, is not satisfactory because solving of the air pollution requires more drastic reduction of the particulate matters. Moreover, the catalyst filter has to have fine mesh openings when to capture the particulate matters having very small diameters. Thus, flow resistance of the exhaust, which is sensed as a kind of “back pressure”, becomes large; and thus, emission efficiency or load on engine becomes large as to increase amount of nitrogen oxides (Nox) and or as to decrease output power of engine or cause an adverse effect on fuel efficiency. The particulate matters may cause clogging of the catalyst filter and thus might even induce fire accident due to rising of temperature in the catalyst filter.

As a way of omitting the filter and improving efficiency of removing the particulate matters, the inventors has proposed a following exhaust cleaner as disclosed in JP-2005-113817 A (Japan's Application Publication No. 2005-113817). The exhaust cleaner is comprised of: inflow and outflow ports for the exhaust gas as disposed to be inserted in an exhaust emission path for a diesel engine; an exhaust gas-liquid contactor configured to make contact between flowed-in exhaust gas and non-mineral oil/fat liquid such as plant oil, which is being introduced to the contactor; and a liquid-gas separator configured to separate the liquid having adsorbed the exhaust particulates from the exhaust gas. The exhaust cleaner exploits affinity between the non-mineral oil/fat liquid and the particulate matters, so as to efficiently remove the hazardous particulates of dark smoke particles or the like.

JP-2003-350097A discloses an exhaust cleaner having largely enhanced efficiency of removing the hazardous percolate matters. FIG. 9 shows a basic mechanism of cyclonic gas-liquid separator used in the exhaust cleaner. A vertical separator barrel 71 is shaped as a circumferential wall of an inverse truncated cone, and its top large-diameter portion is connected with inflow barrel 72 and with outflow barrel 73. The exhaust as a mixture mist with the plant oil flows through the inflow barrel 72 in a tangential direction of the vertical separator barrel 71; and thus flows along a helical arrows line in the figure as a vortex stream. By centrifugal force of a rapid vortex stream, the plant oil having adsorbed the particulate matters falls down on bottom of a collector vessel 74 on beneath of the separator barrel 71 as to be separated from the exhaust. The exhaust thus having gotten rid of majority of the particulate matters flows down as to collide with bottom of the collector vessel 74 and then flows upward as to be discharged through the outflow barrel 73.

Because the inflow and outflow barrels 72 and 73 on the separator barrel 71 are in vicinity of each other, a spot “A” of the plant oil having adsorbed the particulate matters sticks on bottom end portion of the vertical outflow barrel 73 as shown in FIG. 9. Amount of such sticking of the plant oil increases with increase of flowed-in amount. The spots “A” of the plant oil stuck on inner face of the outflow barrel 72 are blown out or pushed out by rapid cyclonic air stream and thereby inevitably flowing out to the air without being removed.

Amount of adsorption of the particulate matters increases with increase of amount of the plant oil. Nevertheless, due to problem in efficiency of gas-liquid separation, ratio of the plant oil admixed to the exhaust is not able to exceed a certain limit. Thus, ratio of removing the particulate matters is in a range of 80-96%, and 100% removal is not achievable, evenwhen cyclonic gas-liquid separator that has been recognized as efficient is used. In order to achieve higher ratio of the removing, increase in dimensions of the air cleaner has been inevitable, and thereby being restricted in respect of range of usage.

In view of the above, it is aimed to achieve efficient separation from gas, of the particulate matters in the exhaust as well as of hazardous particles or dusts in the air or gas without using a device of large dimensions; and in same time to achieve reliable separation and collection of liquid spots that have hazardous substance and are stuck on inner face of the barrel, from the air or gas, as to avoid flowing out of the liquid spots.

### BRIEF SUMMARY OF THE INVENTION

A gas-liquid separator of first aspect of the invention comprises; an inflow barrel; a main cylindrical barrel on downstream of the inflow barrel, which is constructed to induce rotational momentum on to-be cleaned gas having flown in from the inflow barrel; a subordinate cylindrical barrel that has a diameter smaller than that of the main cylindrical barrel and is connected as adjoined to downstream end of the main cylindrical barrel; and an outflow cylindrical barrel that has a diameter smaller than that of the subordinate cylindrical barrel and is connected to downstream end of the subordinate cylindrical barrel.

A gas-liquid separator of second aspect of the invention comprises; an inflow barrel; a main cylindrical barrel on downstream of the inflow barrel, which has an inner barrel duct and is constructed to induce rotational momentum on to-be cleaned gas having flown in from the inflow barrel; a plurality of subordinate cylindrical barrels that have diameters smaller than that of the main cylindrical barrel and are serially connected as adjoined to downstream end of the main cylindrical barrel; a connector cylindrical barrel that has diameter smaller than those of the subordinate cylindrical barrels and connects inside spaces of the subordinate cylindrical barrels; and liquid receivers on beneath of the subordinate cylindrical barrels; and an outflow barrel at downstream end of the series of the subordinate cylindrical barrels.

An exhaust cleaner of the invention comprises; the gas-liquid separator; and a contactor that is configured to introduce liquid for adsorption and contact the liquid with exhaust flowed into the contactor; and wherein the liquid having adsorbed the particulate matters, along with the exhaust, flows into the gas-liquid separator as to be separated from the exhaust.

An air cleaner of the invention comprised; the gas-liquid separator; and a contactor that is inserted as connected in a circulation path of air and is configured to introduce water or other liquid for adsorption and contact the liquid with air flowed into the contactor; and wherein the liquid having adsorbed the dusts, along with the exhaust, flows into the gas-liquid separator as to be separated from the air.

### BRIEF DESCRIPTION OF THE DRAWING

FIG. 1 is a circuit diagram of an exhaust cleaner of first embodiment of the invention, with schematically sectional illustrations of devices;

FIG. 2 is a sectional view of a contactor illustrated in the FIG. 1, with indications of streams of exhaust and plant oil;

FIG. 3 is a partially broken perspective view of a gas-liquid separator in the first embodiment;

FIG. 4 is a vertical sectional view seen from width direction, of the gas-liquid separator of the FIG. 3;

FIG. 5 is a vertical sectional view seen from upstream end, along C-C line of the FIG. 3;

FIG. 6 is a vertical sectional view seen from upstream end, along D-D line of the FIG. 3;

FIG. 7 is a schematic illustration of whole and parts of an air cleaner using the gas-liquid separator of the FIG. 3;

FIG. 8 is a schematic illustration of whole and parts of a sterilizing air cleaner using the gas-liquid separator of the FIG. 3;

FIG. 9 is a schematic vertical sectional view of a conventional cyclonic gas-liquid separator.

### DETAILED DESCRIPTION OF THE INVENTION

First embodiment of the invention is explained hereafter by an example employed on an exhaust cleaner for diesel engine, in line with the drawings.

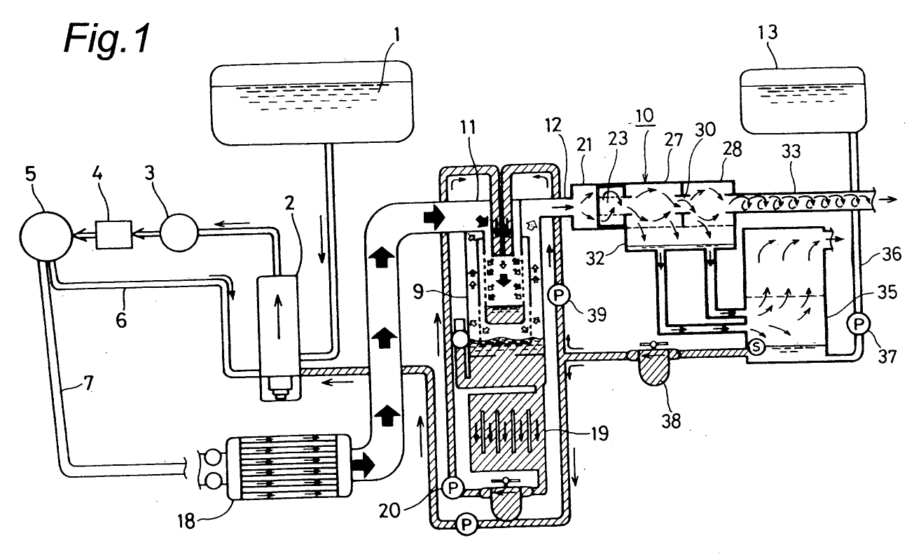

FIG. 1 shows an over-all construction of the exhaust cleaner as well as fuel pathways for the diesel engine. Fuel such as gas oil is supplied from a fuel tank 1 and then dispersed as mixed with air in an air-fuel mixer 2, and flows through a fuel filter 3 and fuel jet pump 4 as to be combusted in the diesel engine. Residual fuel is retuned from the engine to the air-fuel mixer 2 through a return pipe 6 as to form a “fuel circuit”. On downstream of an emission pipe 7 on the engine 5, disposed as connected are a gas-liquid contactor 9 and gas-liquid separator 10.

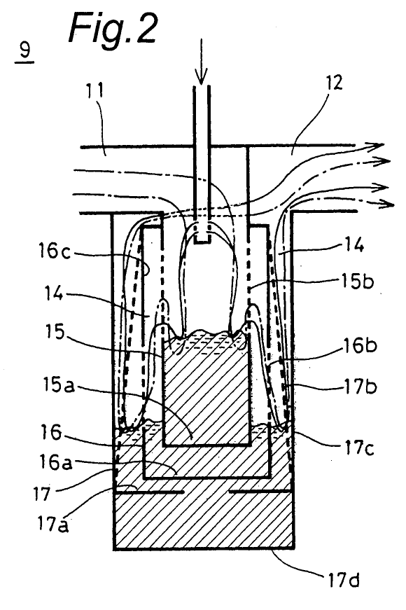

The gas-liquid contactor 9 mixes and agitates the plant oil with the exhaust as to exploit liquid-surface adsorption, due to affinity with the particulate matters, of the plant oil such as soybean oil; so as to capture and collects the particulate matters, which are hazardous particulates in dark smoke of the exhaust. Into oil reservoirs in the gas-liquid contactor 9, pumped is the plant oil from a plant oil tank 13 that is separate with the contactor 9, in a manner to achieve admixing about 10 wt % of the plant oil such as soybean oil, to the gas oil. The exhaust gas flows into an inner space 14 of the contactor 9, through its inflow port 11, and contacted with the plant oil by plural stages in the inner space 14 that is constructed to achieve a large area of contacting between the plant oil and the exhaust. Then, the exhaust gas flows out through an outflow port 12 of the contactor 9. An example of a detailed construction of the gas-liquid contactor 9 is shown in FIG. 2, in which plural of oil reservoir vessels having different diameters are overlaid together in a similar manner with a nested arrangement. In an illustrated example, three cylindrical vessels 15, 16 and 17 are coaxially overlaid.

The exhaust emitted from the engine 5 is in high temperature while flash point of the soybean oil is 280° C. For this reason, a heat exchanger 18 is disposed on an exhaust gas channel between the engine and the contactor 9, as to cool the exhaust to about 180-200° C., which is lower than flash points of the plant oils, before flowing into the contactor 9 and thereby curb fuming of the plant oil. On bottom of each of the cylindrical vessels 15, 16 and 17, a reservoir 15a, 16a or 17a of plant oil is formed. At above the reservoir 15a, 16a or 17a, the cylindrical vessel 15, 16 or 17 has perforations 15b, 16b or 17b. Only the perforations 17b of outermost vessel 17 is formed on a conical wall inserted in the outermost vessel. As indicated by arrows, the exhaust having flown into the contactor 9 rapidly flows downward into the innermost vessel 15 and contacted as collided with the plant oil kept in the reservoir 15a as to form mixture mist of the exhaust and the plant oil, which splashes out from the reservoir 15a. By such a way of contacting between the exhaust gas and the plant oil, the particulate matters in the exhaust are adsorbed in the plant oil. And, the mixture mist then flows out from the innermost vessel 15 through its numerous perforations 15b and then collides with vertical wall 16c of the intermediate vessel 16. The perforations 15b maybe formed not only by punching of a metal sheet or wall but also by attaching a mesh sheet on wall or windows of the vessel. The mixture mist then flows downward along the wall 16c and leaves some liquid as to be received in the reservoir 16a on bottom of the intermediate vessel 16. The mixture mist then splashes out from the reservoir 16a and flows out through perforations 16b of the vessel 16 toward the outermost vessel 17. In this way, area size for contacting between the exhaust and the particulate matters is enlarged as to achieve more sufficient adsorption.

The exhaust gas, particulate matters of which has been adsorbed by the plant oil, flows upward along wall 17c of the outermost vessel 17 and flows out from the contactor 9 through outflow port 12 at top of the outermost vessel 17. Meanwhile, the plant oil flows down from the reservoir 17a at bottom of the outermost vessel 17 into a return reservoir 17d at beneath of the vessel 17, flows through an oil cooler 19 as to be cooled and then is pumped back into the contactor 9 by a pump 20 as to flow into the innermost vessel 5 and to form an oil circulation circuit. Thus, the plant oil having been cooled at the oil cooler 19 returns to the contactor 9 as to further cool the exhaust gas, while the plant oil as mixture mist with the exhaust flows into gas-liquid separator 10 disposed next to the contactor 9. If the exhaust gas has been fully cooled at the heat exchanger 18, the oil cooler 19 may be omitted.

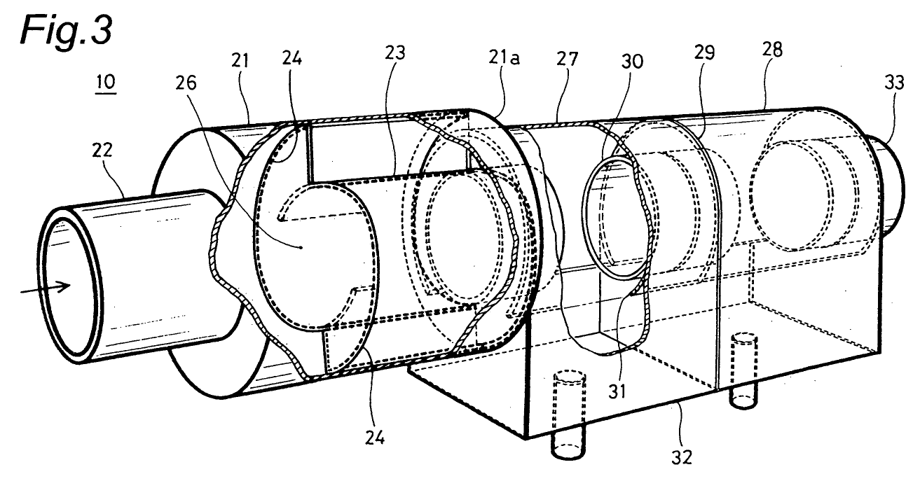

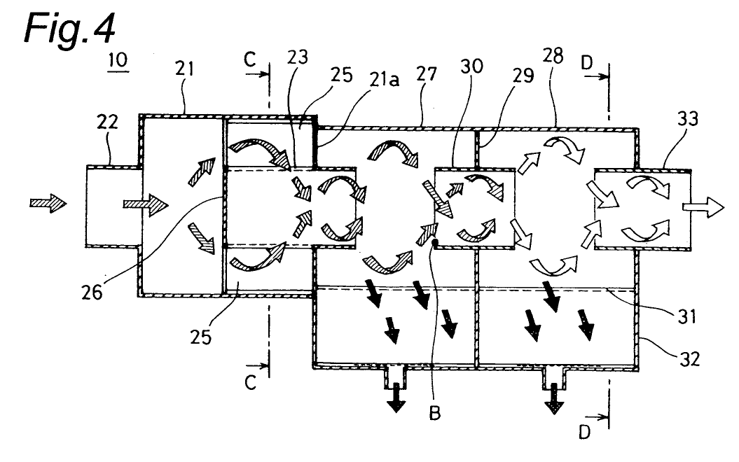

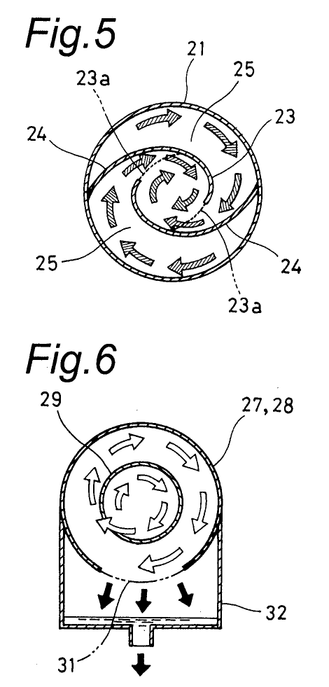

The gas-liquid separator 10 is shown in a partially broken perspective view of FIG. 3 and in a side-wise sectional view of FIG. 4, and includes: an outer barrel 21 in a hollow cylinder shape, an inflow barrel 22 on an end of the outer barrel 21, a cylindrical inner barrel duct 23 that is distanced from the inflow barrel 22 by a small gap. As clear from FIG. 5, which is a cross sectional view seen from the inflow barrel 22, the inner barrel 23 consists of, other than upstream end plate 26, two identical parts that are arch shape in the cross section and arranged to form two identical side-face openings 23a, which run all over the length of the inner barrel duct 23 until reaching downstream end 21a of the outer barrel 21. From a longitudinal edge of each of the arch-shape parts, which defines the side-face opening 23a, a guide plate 21 in a substantially arch shape in cross section is smoothly and helically extended to reach and connect on the outer barrel 21, so as to form a guide channel 25 along each of the guide plate 21. An end plate 26 covers upstream end opening of the inner barrel 23 and horn-shaped opening areas, each of which is sandwiched between the inner barrel 23 and one of the guide plates 21. By these constructions, the exhaust flows in through the inflow barrel 22, collides with the end plate 26 as to be made to flow along circumferential direction and then flows into the guide channel 25 as to flow along the guide plates 24. Thus, the exhaust gas flows in a helical or rotational stream when flowing into the inner barrel duct 23, and then flows to downstream end opening of the inner barrel duct 23.

On downstream end of the outer barrel 21, cylindrical barrels 27, 28 having diameters somewhat smaller than that of the outer barrel 21 are serially connected as to be adjoined with next ones. Partition wall 29 between the two cylindrical barrels 27, 28 is penetrated by a connection barrel 30 having a diameter same with that of the inner barrel duct 23, as to perforate the partition wall 29 other than fringe areas. As shown in FIG. 6, the cylindrical barrels 27, 28 on both sides of the connection barrel 30 have downfall openings 31 on their bottom parts all over their length dimension. Width dimension of the openings 31 is almost same with that of the inner barrel 23; and liquid receivers 23 are provided on beneath of the openings 31. On downstream end of the cylindrical barrel 28, outflow barrel 33 is provided.

Number of the side-face openings 23a of the inner barrel 23 may be three or more instead of two in the above. The inner barrel duct 23 is not have to be cylindrical, and may be shaped by, and at center part of, a combination of curved guide plates 24 that run along arches or helical lines in view of cross section.

By construction in the above, the mixture mist of the exhaust gas flows, as indicated by arrows in the figures, into the outer barrel 21 through the inflow barrel 22, collides with the end plate 26 as to spread to outer parts and then flows into guide channels 25 along the guide plates 24. Subsequently, the mixture mist flows through the side-face openings 23a into the inner barrel 23 as to be given with rotational momentum, and then flows through downstream end of the inner barrel 23 as to flow into the cylindrical barrel 27 as a vortical stream. The vortical stream of the exhaust forms a kind of cyclone as entered into the cylindrical barrel 28, by expansion and centrifugal force. Thus, in the cylindrical barrel 27, the plant oil having adsorbed the particulate matters is separated from the exhaust falls down through openings 31, by action of centrifugal force and gravity, into liquid receivers 32 at underneath.

The plant oil further flows down into the collector tank 35 by action of pressure in the cylindrical barrel 27 and gravity of the plant oil itself. Thus, the plant oil is not stored in the liquid receivers 32 and thus is not blown up by the vortical stream. The collector tank 35 has inflow ports, through which the plant oil flows in, and is connected with oil feeding pipe 36 that leads fresh plant oil from a plant oil tank 13 located at above the collector tank 35. A sensor S1 for detecting plant oil level in the collector tank 35 is provided there, and activates a pump 37 as to replenish the plant oil by supplying the fresh plant oil from the tank 13. The plant oil in the collector tank 35 flows through an oil filter 38 and through a flow-splitting junction, from which part of the plant oil flows through a pump 39 and then returns to the contactor 9; and other part of the plant oil flows from the junction to the air-fuel mixer 2 disposed on a fuel piping between the fuel tank 1 and the engine 5, so as to be mixed with gas oil in a stable mixing ratio between the gas oil and the plant oil having adsorbed the particulate matters; and thereby, the plant oil and the particulate matters are supplied to and burned in the engine 5, together with the gas oil.

Temperature in the engine 5 is around 2000° C., and is far higher than combustion temperature of carbon particles, which is in a range of 600-700° C. Thus, the particulate matters in the plant oil are completely burned in the engine. By control using the sensor S1, fresh plant oil is supplied from the plant oil tank 13 into the collector tank 35 as to compensate decrease of the plant oil due to combustion; and thereby, abnormal rising in concentration or weight ratio of the particulate matters in the plant oil is curbed, and thus clogging of the oil filter 38 is curbed. Moreover, damaging on combustion or on exhaust emission piping is curbed. Meanwhile, the exhaust gas, from which the particulate matters is removed in the cylindrical barrel 27, flows into the connector barrel 30 and then into the next cylindrical barrel 28. The connector barrel 30, at near of its upstream opening, is covered as stuck with a spot B (FIG. 4) of the plant oil. The spot B is formed as follows. The exhaust gas having been in the vortex stream passes through the connector barrel 30 having smaller diameter and thus is depressurized. And, the plant oil in a mist state and slightly remained in the exhaust makes successive and gradual deposition on the spot B. Amount of the deposition is extremely small compared to the plant oil collected into the receiver 32. Nevertheless, a 20 mL of the spot B will be formed from 20 L of the plant oil having adsorbed the particulate matters, on assumption that; 99% of the plant oil is separated from the exhaust before passing the connector barrel 30 by the above construction of the contactor 9 and the gas-liquid separator 10, and that; exhaust emission rate is 30 m³ per minute. The spot B of the plant oil stuck on the connector barrel 30 gradually moves toward downstream as to reach downstream end of the connector barrel 30 and flows into the next cylindrical barrel 28. Then, under centrifugal force in the cylindrical barrel 28, the spot B of the plant oil falls down through the opening 31 into the receiver 32 and collected. Thus, near 100% of the particulate matters of the exhaust gas is removed at a time the gas is emitted through the outlet pipe 33, so that a clean gas is emitted to the air.

In conventional technique, the spot B of the plant oil has been emitted without being separated by a gas-liquid separator using the centrifugal force. Thus, filter device or the like has been needed for removing the plant oil still remained by a several percentage after passing a cyclonic gas-liquid separator. Thus, production cost has become higher and space for accommodation has become larger, by such filter device or the like. In other words, the device of the embodiment achieves a simple structure and smaller space requirement for mounting and thereby smaller production cost because no additional mechanism for removing the remained fraction of the plant oil.

If and when separation of the plant oil is insufficient due to relatively small pressure of the emission of the exhaust or due to relatively large amount of the plant oil compared to the exhaust gas, another or plural of the cylindrical barrel 28 and the connector barrel 30 are to be serially connected.

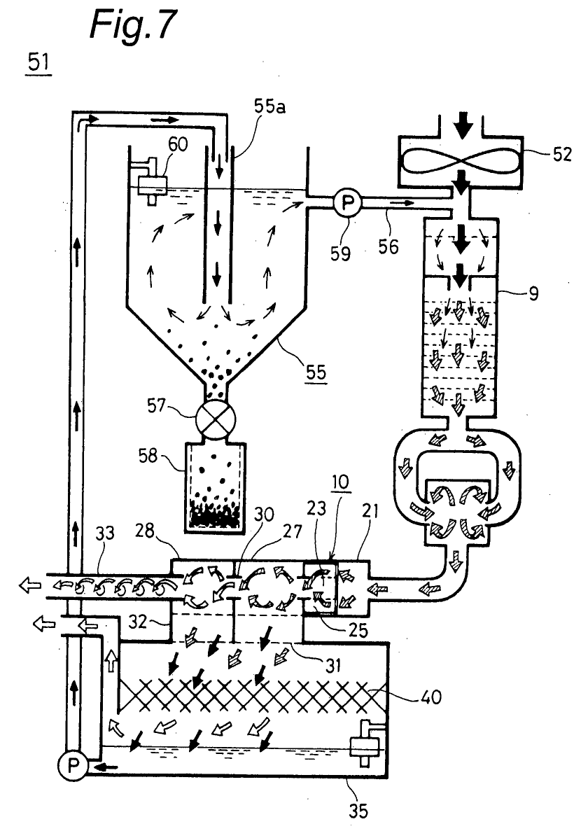

In the above explanation, the gas-liquid separator is used for removing the particulate matters from the exhaust emitted from a diesel engine. Nevertheless, the gas-liquid separator of the invention may be used in various kinds of air cleaner. For example, in an example shown in FIG. 7 having same reference numerals for respectively identical parts, the gas-liquid separator 10 is used in a dust collector. On downstream of a blower 52, the contactor 9 same as in the above embodiment is arranged. Construction of the gas-liquid separator 10 also is same as in the above embodiment, as follows. The outer barrel 21 is connected as adjoined with two cylindrical barrels 27 and 28 in a series, and has at inside, the inner barrel 23 and the guide channel 25 that gives air sent from the blower 52 a rotational momentum. The cylindrical barrels 27 and 28 have a connector barrel 30 between them, at center part in cross section of the barrels 27 and 28. The cylindrical barrels 27 and 28 have, at their bottom parts, downfall openings 31 and have liquid receivers 32 at beneath of the barrels. The outflow barrel 33 is provided on downstream end of the second cylinder barrel 28, as to emit cleaned air.

The liquid receivers 32 are connected with collector tank 35 so that liquid, e. g. water, having adsorbed dust and been received in the receivers 32 flows into the collector tank 35 under pressure in the cylindrical barrel 27 and gravity of the liquid itself. Thus, the liquid would not be stored in a manner of a reservoir in the liquid receivers 32, and hence not blown back upward by the vortex air stream. In the collector tank 35, the liquid in a mist state is collected by a demister 40 so that cleaned air is discharged from outlet port at a top portion on downstream end and the liquid is led to precipitation reservoir 55 on downstream of the collector tank 35. The precipitation reservoir 55 is provided with, at its top part, an inlet pipe 55a for introducing the water having adsorbed the dust from the collector tank 35. The dust precipitates to bottom of the precipitation reservoir 55 and flows down through a valve 57 as to be collected by a cartridge filter 58, which is detached as needed or periodically as to be discarded.

Water at top part of the precipitation reservoir 55 has few dirty and is returned to the contactor 9 through circulation pipe 56 by action of pump 5, as to be contacted with air having dirt for serving in cleaning of the air. When water level in the precipitation reservoir 55 falls down, the float switch 60 detecting the water level actuates a not-illustrated pump as to replenish the water by supplying of fresh water. By the above construction, air having dust as generated at manufacturing facility is cleaned to be get rid of the dust, by the contactor 9 and the gas-liquid generator 10, so that cleaned air is discharged from emission pipe 33 at downstream end of the gas-liquid separator 10.

The gas-liquid separator 10 may be employed in deodorizing equipment. The blower 52 and the gas-liquid separator is arranged as in the air cleaner 51 in the above; and arranged are a contactor for contacting the air and the deodorizing catalyst liquid as well as a reservoir for the catalyst liquid in place of the precipitation reservoir 55 in the above. By this construction, air with foul odor in a painting facility or in a food processing facility is introduced by the blower as to flow through the contactor and the gas-liquid separator. Introduced air is contacted as mixed with the catalyst liquid, and then the liquid having adsorbed the odor molecules are separated from the air in the gas-liquid separator by action of vortex stream. Thus, cleaned air having gotten rid of odor molecules is sent out, while the catalyst liquid is led into the reservoir as to return to the contactor 9 and again serves for capturing the odor molecules. When amount of the catalyst liquid in the reservoir falls down, required amount of fresh catalyst liquid is supplied for replenishment so that the catalyst liquid is used as circulated.

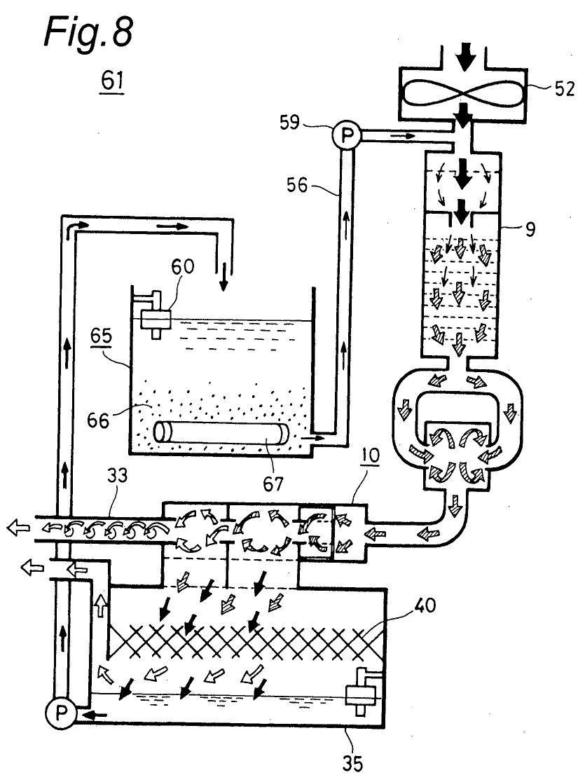

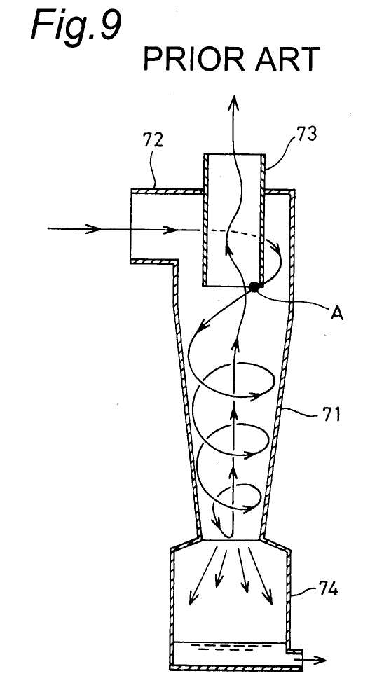

Explained below is an embodiment using the gas-liquid separator in a sterilizing air cleaner for sterilizing bacteria and virus and the like and purifying the air. An embodiment shown in FIG. 8 having same reference numerals for respectively identical parts is in a same manner with the above embodiment of the air cleaner. The sterilizing air cleaner has the blower 52, the gas-liquid separator 10 as well as the contactor 9 for contacting air with liquid such as water and the collector tank 35 as in the exhaust cleaner, and a sterilizing tank 65 in place of the precipitation reservoir 55. Air having bacteria and viruses as suspended in the air is forced by the blower 33 to circulate through the contactor 9 and the gas-liquid separator 10 so that the bacteria or the like in the air are adsorbed to the water by mixing the water with the air, and such water is separated from the air in the gas-liquid separator. Thus cleaned air having gotten rid of the bacteria or the like is discharged from emission pipe 33 of the gas-liquid separator 10, while the water having captured the bacteria and viruses is led to the collector tank 35 as in the foregoing embodiments. In the collector tank 35, the liquid in a mist state is captured by the demister 4 and falls down on bottom of the collector tank 35 as to be led to the sterilizing tank 65 on downstream of the tank 35; and cleaned air is discharged from an outlet port on a top portion of the collector tank 35.

In the sterilizing tank 65, titan oxide powder 66 as photo catalyst having fine diameters is admixed as suspended in water. The titan oxide powder 66 is activated as excited by ultraviolet irradiation using a UV lamp 67 and then exhibits strong oxidation effect as to destroy the bacteria and viruses and to decompose organic compounds in the water. By such decomposition, the organic substances are decomposed to become carbon dioxide and water as to achieve efficient purification of the water. Because of fine diameters of the titan oxide powder 66, magnitude of total surface area becomes maximized as to achieve highly efficient sterilization. Circulation of the excited titan oxide catalyst without stopping enhances the sterilization efficiency. Photo catalyst other than the titan oxide may be used; and adoptable are not only powder catalyst but also catalyst painted on inner face on the tank or on ceramic balls or the like placed in the water. The ultraviolet irradiation for exciting the catalyst may be made not only by the UV lamp or LED but also by high-voltage discharge. The water retained in the sterilizing reservoir 65 is, after sterilization by the photo catalyst, returned by action of the pump 59, through the circulation pipe into the contactor 9, and serves again for adsorbing the bacteria and viruses by contacting with the air to be purified. When water level in the satirizing reservoir 65 deviates from a certain range, the float switch 60 detects it. If the water level becomes lower than the certain range, freshwater is supplied for replenishment from not-illustrated water tank separately provided. If the water level becomes higher than the certain range, operation of the air sterilizing device is stopped for securing of safety. By the sterilizing air cleaner of this embodiment, bacteria and viruses suspended in the air within buildings such as hospital is mixed with and adsorbed in water. Thus cleaned air as separated from water by the gas-liquid separator is discharged to outside, while the bacteria and harmful substances adsorbed in the water is destroyed or treated in the sterilizing tank.

As explained hereto, the gas-liquid separator of the invention has high degree of gas-liquid separation ability and is able to be formed by only a simple construction and be mounted in a small space. Due to no need of using a filter device, cost for production is decreased and maintenance work is simplified or alleviated. Dust particles are eliminated irrespective to their dimension of diameters because collecting of the particles is made by using a liquid. Moreover, by using the gas-liquid separator, achieved are the exhaust gas cleaner for the diesel engine, air cleaner and sterilizing air cleaner, which are cheap and compact-sized and have high efficiency.

What is claimed is:

1. A gas-liquid comprising: an inflow barrel; a main cylindrical barrel on downstream of the inflow barrel and is constructed to induce rotational momentum on gas-liquid mixture having flown in from the inflow barrel; a subordinate cylindrical barrel that has a diameter smaller than that of the main cylindrical barrel and is connected as adjoined to downstream end of the main cylindrical barrel; and an outflow cylindrical barrel that has a diameter smaller than that of the subordinate cylindrical barrel and is connected to downstream end of the subordinate cylindrical barrel.

2. A gas-liquid separator comprising: an inflow barrel; a main cylindrical barrel on downstream of the inflow barrel, which has an inner barrel duct and is constructed to induce rotational momentum on gas-liquid mixture having flown in from the inflow barrel; a plurality of subordinate cylindrical barrels that have diameters smaller than that of the main cylindrical barrel and are serially connected as adjoined to downstream end of the main cylindrical barrel; a connector cylindrical barrel that has diameter smaller than those of the subordinate cylindrical barrels and connects inside spaces of the subordinate cylindrical barrels; and liquid receivers on beneath of the subordinate cylindrical barrels; and an outflow barrel at downstream end of the series of the subordinate cylindrical barrels.

3. A gas-liquid separator according to claim 2, further comprising: a partition occluding upstream port of the inner barrel duct; plural of openings on circumferential wall of the inner barrel duct; guide plates each extending as smoothly curved substantially along an arch, from an edge defining the opening, as to connect on inner face of the main cylindrical barrel; and wherein the guide plate gives the rotational momentum to the gas-liquid mixture at a time the mixture flows inward into the inner barrel duct along the guide plate, as to achieve gas-liquid separation by vortex stream in the inner barrel duct, under action of centrifugal force.

4. A gas-liquid separator according to claim 2, further comprising: a partition wall that is disposed at junction between the subordinate cylindrical barrels as to partition inner spaces of the subordinate cylindrical barrels; and wherein the connector cylindrical barrel is arranged to penetrate to open center part of the partition.

5. A gas-liquid separator according to claim 2, further comprising: downfall openings on bottom portions of the subordinate cylindrical barrels; and liquid receivers on beneath of the downfall openings as to receive liquid separated by the vortex stream and fallen through the downfall openings.

6. A exhaust cleaner comprising; the gas-liquid separator according to claim 1; and a contactor that is configured to introduce liquid for adsorption and contact the liquid with exhaust flowed into the contactor; and wherein the liquid having adsorbed particulate matters, along with the exhaust, flows into the gas-liquid separator as to be separated from the exhaust, while cleaned air being discharged.

7. A exhaust cleaner comprising; the gas-liquid separator according to claim 2; and a contactor that is configured to introduce liquid for adsorption and contact the liquid with exhaust flowed into the contactor; and wherein the liquid having adsorbed particulate matters, along with the exhaust, flows into the gas-liquid separator as to be separated from the exhaust, while cleaned air being discharged.

8. An air cleaner comprising; the gas-liquid separator according to claim 1; and a contactor that is inserted as connected in a circulation path of air and is configured to introduce water or other liquid for adsorption and contact the liquid with air flowed into the contactor; and wherein the liquid having adsorbed dusts, along with the air, flows into the gas-liquid separator as to be separated from the air, while cleaned air being discharged.

9. An air cleaner comprising; the gas-liquid separator according to claim 2; and a contactor that is inserted as connected in a circulation path of air and is configured to introduce water or other liquid for adsorption and contact the liquid with air flowed into the contactor; and wherein the liquid having adsorbed dusts, along with the air, flows into the gas-liquid separator as to be separated from the air, while cleaned air being discharged.

10. An air cleaner comprising; the gas-liquid separator according to claim 2; and a contactor that is inserted as connected in a circulation path of air and is configured to introduce water or other liquid for adsorption and contact the liquid with air flowed into the contactor; and wherein the liquid having adsorbed bacteria and viruses, along with the air, flows into the gas-liquid separator as to be separated from the air, while cleaned air being discharged.

11. An sterilizing air cleaner comprising; the gas-liquid separator according to claim 2; a contactor that is inserted as connected in a circulation path of air and is configured to introduce water or other liquid for adsorption and contact the liquid with air flowed into the contactor; and a sterilizer device; and wherein the liquid having adsorbed bacteria and viruses, along with the air, flows into the gas-liquid separator as to be separated from the air, and then satirized in the sterilizer device, while cleaned air being discharged.
